(19) United States
(12) Patent Application Publication
(10) Pub. No.: US 2012/0148853 A1
(43) Pub. Date: Jun. 14, 2012

(54) INSULATOR

(75) Inventors: Jin Wakamatsu, Toyota-shi (JP); Hisashi Ando, Anpachi-gun (JP); Kenzo Saiki, Ibi-gun (JP)

(73) Assignees: IBIDEN CO., LTD., Gifu (JP); TOYOTA JIDOSHA KABUSHIKI KAISHA, Toyota-shi (JP)

(21) Appl. No.: 13/391,545

(22) PCT Filed: Aug. 21, 2009
(86) PCT No.: PCT/JP09/64664

§ 371 Date: Feb. 21, 2012

(51) Int. Cl. B32B 15/04

(52) U.S. Cl. 428/457

(57) ABSTRACT

An insulator disposed in opposition to an exhaust manifold of an internal combustion engine with spacing therebetween is constituted as follows. A metal base having heat resistance is provided, a surface covering layer obtained by surface treatment is not provided on a first region of an outer surface of the base, the outer surface being on the side that is not in opposition to the exhaust manifold, and a surface covering layer obtained by the surface treatment is provided on a second region. The first region of the outer surface of the base is a region in opposition to peripheral components disposed in the vicinity of the outer surface of the base. In this case, the material of the base is aluminum or an aluminum alloy, and the surface treatment performed on the outer surface of the base is black alumite treatment.

### TECHNICAL FIELD

The present invention relates to an insulator that is disposed in opposition to exhaust system components of an internal combustion engine with spacing therebetween.

### BACKGROUND ART

An insulator is a member for thermal insulation that is disposed in opposition to exhaust system components of an internal combustion engine such as, for example, an exhaust manifold, an exhaust pipe, and a catalytic converter with spacing therebetween. The insulator suppresses the propagation of radiant heat from the exhaust system components to components disposed on the periphery of the exhaust system components, thereby suppressing heat damage to the peripheral components. Further, an insulator is used not only as a countermeasure to heat damage to peripheral components, but also as a countermeasure to noise and a countermeasure to vibration.

An insulator has a metal base having heat resistance. The base of an insulator is formed using aluminum, an aluminum alloy, or the like, for example. Conventionally, it has been proposed to perform various types of surface treatment on the surface of a base of an insulator in order to enhance performance of the insulator (e.g., see PTL 1 and 2).

PTL 1 and 2 disclose that the heat radiation rate (thermal emissivity) of an insulator is changed by forming a coat (surface covering layer) on the surface of a base of the insulator. Examples of surface treatment for increasing the heat radiation rate of an insulator include blackening treatment for blackening the color of the base surface of an insulator and the like. Examples of such blackening treatment include black coating treatment disclosed in PTL 1 and 3, black alumite treatment disclosed in PTL 2, and the like.

Further, it is known that the strength of an insulator is increased by forming a coat (surface covering layer) on the surface of a base of an insulator. Examples of surface treatment for increasing the strength of an insulator include hardening treatment and the like. Examples of such hardening treatment include alumite treatment and the like. Note that PTL 4 discloses that the strength of an insulator is increased by machining the surface of a base of the insulator.

Examples of other conventional techniques related to insulators include techniques described in PTL 5 and 6. PTL 5 discloses that a shock absorbing material is provided at a bolt fitting portion of an insulator, thereby improving a vibration suppressing function. PTL 6 discloses that a heat transfer material, a heat insulating material, and the like are provided in a gap between an insulator and an exhaust manifold, thereby uniformly adjusting the temperature of portions of the exhaust manifold.

### CITATION LIST

### Patent Literature

PTL 1: JP H6-336923A
PTL 2: JP H5-47339U
PTL 3: JP H3-62798B
PTL 4: JP 2004-92543A
PTL 5: JP 2004-360496A
PTL 6: JP 2008-240589A

### SUMMARY OF INVENTION

### Technical Problem

Various problems may occur if a surface covering layer is formed by performing surface treatment as described above on the entire outer surface of a base of an insulator.

An example of such problems is that if blackening treatment is performed on the entire outer surface of a base of an insulator in order to increase the heat radiation rate of the base of the insulator, the amount of dissipated heat increases in the entire outer surface of the base of the insulator. Accordingly, there is concern about an increase in heat damage to peripheral components disposed in the vicinity of the insulator, such as, for example, various electrical devices, harnesses, and hoses in the engine room of a vehicle.

Further, an example of such problems is that if hardening treatment is performed on the entire outer surface of a base of an insulator in order to increase the strength of the insulator, deformation resistance is deteriorated in the entire base of the insulator. Accordingly, there is concern about cracks and the like being easily formed in the outer edge portion of the base of the insulator or the circumference portion of an opening that are likely to be subjected to stress due to vibration if vibration from the vibration source such as an exhaust manifold is transmitted to the insulator.

The present invention has been conceived in light of such points, and an object thereof is to solve various problems such as those described above by omitting the provision of a surface covering layer on a specific region, rather than providing the surface covering layer on the entire outer surface of a base of an insulator.

### Solution to Problem

Means of the present invention for solving the above problems are configured as follows. Specifically, the present invention is an insulator disposed in opposition to an exhaust system component of an internal combustion engine with spacing therebetween, the insulator including: a metal base having heat resistance, wherein a surface covering layer obtained by surface treatment is not provided on a partial region of an outer surface of the base, the outer surface being on a side that is not in opposition to the exhaust system component, and the surface covering layer obtained by the surface treatment is provided on a remaining region.

According to this configuration, it is possible to solve various problems that occur in a case in which a surface covering layer is provided on the entire outer surface of the base, by omitting the provision of the surface covering layer on a specific region (partial region), rather than providing the surface covering layer on the entire outer surface of the base. Note that “surface treatment” means treatment for forming a certain coat, layer, or the like on the base, and does not include processing in which such a coat, layer, or the like is not formed on the base (e.g., machining), and the like. Here, it is preferable to mask the partial region of the outer surface of the base, prior to the surface treatment. In this way, by simple means, namely, partially masking the outer surface of the base prior to the surface treatment, the partial region on which the surface covering layer is not provided and the remaining region on which the surface covering layer is provided can be easily formed on the outer surface of the base. Note that masking is not included in “surface treatment”.

The following three configurations are specific aspects of surface treatment to be performed on the outer surface of the base and a partial region of the outer surface of the base in the present invention.

(1) A configuration in which the surface treatment is surface treatment for increasing the heat radiation rate, and the partial region includes a region in opposition to a peripheral component disposed in the vicinity of the outer surface of the base (referred to as “first configuration”).

(2) A configuration in which the surface treatment is hardening treatment for increasing strength, and the partial region includes the outer edge portion of the base (referred to as “second configuration”).

(3) A configuration in which the surface treatment is surface treatment for increasing the heat radiation rate and strength, and the partial region includes a region in opposition to the peripheral component disposed in the vicinity of the outer surface of the base, the outer edge portion of the base, and the circumference portion of an opening provided in the base (referred to as “third configuration”).

First, according to the first configuration, a region in opposition to the peripheral component is included in the partial region on which the surface treatment for increasing the heat radiation rate is not performed, and thus the following effects are obtained. Specifically, a part of heat radiated from the heat source such as an exhaust system component of an internal combustion engine is absorbed by the base of the insulator, and is radiated (emitted) from the outer surface of the base to the outside. Since the heat radiation rate in the partial region of the outer surface of the base is lower than that in the remaining region, the amount of heat dissipated from the partial region is smaller than the amount of heat dissipated from the remaining region. Consequently, the amount of heat dissipated from the partial region is reduced, compared to the case in which the surface treatment is performed on the entire outer surface of the base. Accordingly, the amount of heat that the peripheral component disposed in the vicinity of the partial region receives from the partial region of the outer surface of the base can be reduced, and thus it is possible to suppress an excessive rise in the temperature of the peripheral component and heat damage to the peripheral component.

On the other hand, the surface covering layer obtained by the surface treatment for increasing the heat radiation rate is provided on the remaining region of the outer surface of the base, and thus the amount of heat dissipated from the remaining region to the outside can be increased. Accordingly, heat dissipation properties of the insulator can be improved as a whole.

In the first configuration, it is preferable that the base is made of aluminum or an aluminum alloy, and the surface treatment is black alumite treatment.

Here, the material of the base and the surface treatment to be performed on the outer surface of the base in the first configuration are more specifically specified. In this way, since the material of the base is aluminum or an aluminum alloy, and the surface treatment is black alumite treatment, the partial region having a low heat radiation rate and the remaining region having a high heat radiation rate can be easily formed on the outer surface of the base.

Next, according to the second configuration, the outer edge portion of the base is included in the partial region on which the surface treatment for increasing strength (hardness) is not performed, and thus the following effects are obtained. Specifically, deformation resistance in the partial region of the outer surface of the base of the insulator is increased, compared to the case in which the surface treatment is performed on the entire outer surface of the base. Accordingly, even if the vibration from the vibration source such as an exhaust system component of the internal combustion engine is transmitted to the base of the insulator, cracks and the like are not easily formed in the outer edge portion of the base. In this way, the durability of the base of the insulator can be secured.

In the second configuration, it is preferable that if an opening is formed in the base, the partial region also includes the circumference portion of the opening.

In this configuration, even if the vibration from the vibration source such as an exhaust system component of the internal combustion engine is transmitted to the base of the insulator, cracks and the like are not easily formed in the circumference portion of the opening of the base. In this way, the durability of the base of the insulator can be secured.

In the second configuration, it is preferable that the base is made of aluminum or an aluminum alloy, and the hardening treatment is alumite treatment.

Here, the material of the base and the surface treatment to be performed on the outer surface of the base in the second configuration are more specifically specified. In this way, since the material of the base is aluminum or an aluminum alloy, and the surface treatment is alumite treatment, the partial region having high deformation resistance and the remaining region having high strength (hardness) can be easily formed on the outer surface of the base.

Note that in the first and second configurations, it is possible to omit the provision of the surface covering layer obtained by the surface treatment on a region of the inner surface of the base on the side in opposition to the exhaust system component, the region being positioned on the back side of the partial region of the outer surface, and to provide the surface covering layer obtained by the surface treatment on a region of the inner surface, the region being positioned on the back side of the remaining region of the outer surface. Specifically, it is also possible to omit the implementation of the surface treatment not only on the specific region (partial region) of the outer surface of the base, but also on a specific region of the inner surface of the base (region positioned on the back side of the partial region) in the same manner.

Next, the third configuration is a configuration in which the first and second configurations are combined. According to this third configuration, effects similar to the effects obtained by the first and second configurations described above are obtained. In this third configuration, it is preferable that the material of the base is aluminum or an aluminum alloy, and the surface treatment to be performed on the outer surface of the base is black alumite treatment.

### Advantageous Effects of Invention

According to the present invention, it is possible to solve various problems that occur in a case in which a surface covering layer is provided on the entire outer surface of a base of an insulator, by omitting the provision of the surface covering layer on a specific region, rather than providing the surface covering layer on the entire outer surface of the base.

### BRIEF DESCRIPTION OF DRAWINGS

FIG. 1 is an exploded perspective view schematically showing a cylinder head, an exhaust manifold, and an insulator of an internal combustion engine according to a first embodiment.

FIG. 2 is a diagram schematically showing the outer surface of a base of the insulator according to the first embodiment.

FIG. 3 is a diagram schematically showing the positional relationship between the insulator and peripheral components.

FIG. 4 is a diagram schematically showing the cross section of a region of the base in opposition to peripheral components.

FIG. 5 is a diagram schematically showing the cross section of a region of the base distant from peripheral components.

FIG. 6 is a flowchart showing the procedure used when partially forming a surface covering layer on the outer surface of the base.

FIG. 7 is a diagram showing an insulator according to a modified example of the first embodiment, and corresponding to FIG. 4.

FIG. 8 is a diagram showing the relationship between the distance from the outer surface of the base to a peripheral component and the surface temperature of the peripheral component.

FIG. 9 is a diagram schematically showing the outer surface of a base of an insulator according to a second embodiment.

FIG. 10 is a diagram schematically showing the cross section of a region including the outer edge portion of the base.

FIG. 11 is a diagram schematically showing the cross section of a region including the circumference portion of an opening provided in the base.

FIG. 12 is a diagram showing an insulator according to a modified example of the second embodiment, and corresponding to FIG. 10.

FIG. 13 is a diagram showing the insulator according to the modified example of the second embodiment, and corresponding to FIG. 11.

### REFERENCE SIGNS LIST

10 Internal combustion engine
12 Exhaust manifold
20 Insulator
21 Base
24 Outer surface
24a First region (partial region)
24b Second region (remaining region)
25 Surface covering layer

### BEST MODE FOR CARRYING OUT THE INVENTION

Embodiments embodying the present invention will be described with reference to the accompanying drawings.

Below is a description of an example in which the present invention is applied to an insulator that covers an exhaust manifold of an internal combustion engine mounted in a vehicle.

### First Embodiment

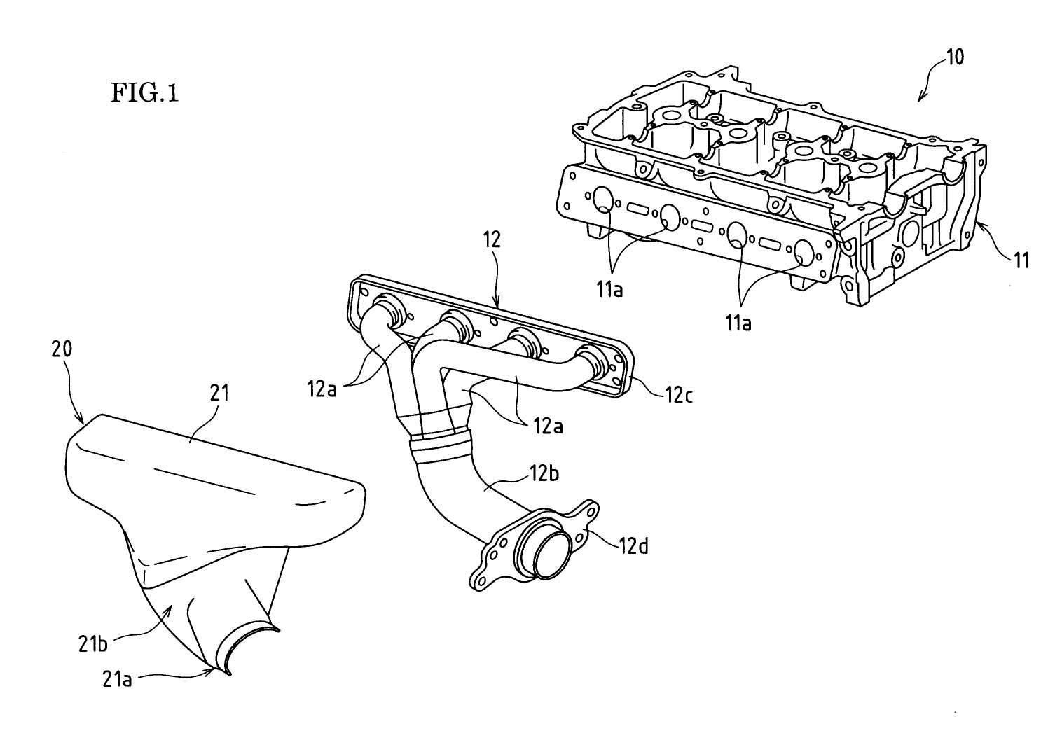

An insulator 20 according to a first embodiment will be descried with reference to FIGS. 1 to 6.

First is a description of a schematic configuration of the insulator 20 according to the first embodiment with reference to FIG. 1. FIG. 1 is an exploded perspective view schematically showing a cylinder head 11, an exhaust manifold 12, and the insulator 20 of an internal combustion engine 10 in the first embodiment.

As shown in FIG. 1, the internal combustion engine 10 is constituted so as to be an in-line 4-cylinder engine, and exhaust port opening portions 11a are formed at four locations in the side surface of the cylinder head 11. A cylinder block and a head cover are respectively attached to the lower portion and the upper portion of the cylinder head 11.

In the exhaust system of the internal combustion engine 10, exhaust system components such as the exhaust manifold 12, an exhaust pipe, a catalytic converter, and a muffler (omitted from the drawings) are provided. The exhaust manifold 12 collects exhaust gas discharged from each of the exhaust ports of the cylinder head 11 of the internal combustion engine 10. Then, the exhaust gas gathered by the exhaust manifold 12 is purified by the catalytic converter, and thereafter muffled by the muffler, and discharged outside.

The exhaust manifold 12 is provided with four branch pipes 12a corresponding to the cylinders of the internal combustion engine 10, and a junction pipe 12b that joins the downstream ends of these branch pipes 12a. A flange 12c is integrally attached to the upstream ends of the branch pipes 12a by means such as welding. The exhaust manifold 12 is integrally attached to the cylinder head 11 by attaching the flange 12c to the side surface of the cylinder head 11. Further, a flange 12d is integrally attached to the downstream end of the junction pipe 12b by means such as welding. The exhaust manifold 12 is connected to the exhaust pipe on the downstream side via the flange 12d.

The insulator 20 having a thermal insulation function, a sound insulation function, a vibration suppressing function, and the like is provided on the outer side of the exhaust manifold 12. The insulator 20 is shaped so as to cover the upper portion of the exhaust manifold 12 from above. The insulator 20 is arranged in opposition to the exhaust manifold 12 with spacing therebetween. The insulator 20 is attached to the exhaust manifold 12 by means such as bolt fastening.

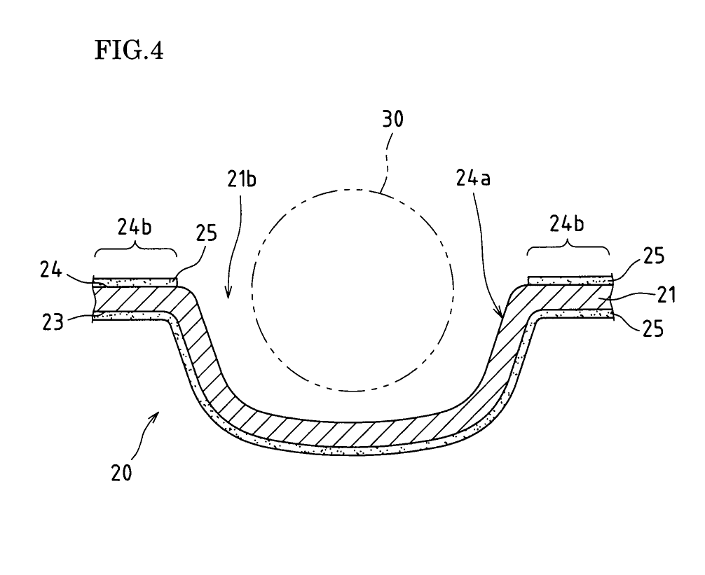

The insulator 20 is provided with a metal base 21 having heat resistance. In this embodiment, the insulator 20 is constituted by one base 21. The base 21 is a thin member made of aluminum or an aluminum alloy. The base 21 is provided with a protruding portion 21a that protrudes in the same direction as the direction in which the junction pipe 12b of the exhaust manifold 12 curves. Note that in the following, out of the both surfaces of the base 21, the surface on the side in opposition to the exhaust manifold 12 is referred to as an inner surface 23, and the surface on the side that is not in opposition to the exhaust manifold 12 is referred to as an outer surface 24 (see FIG. 4, etc.).

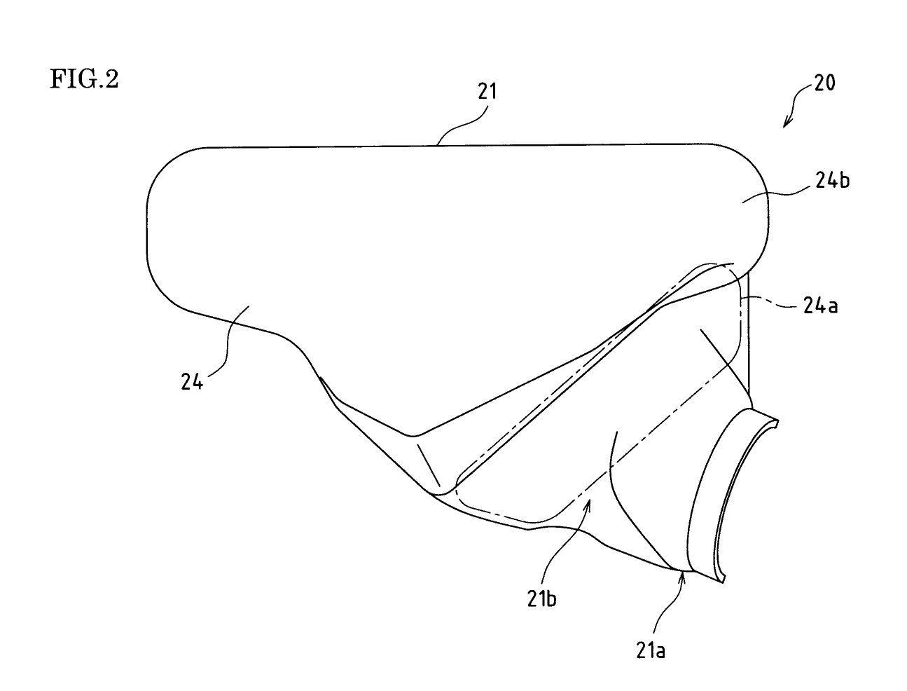

A feature of this embodiment is that surface treatment is not performed on a specific region, rather than performing surface treatment on the entire outer surface 24 of the base 21 of the insulator 20. Specifically, a feature is that although a surface covering layer obtained by surface treatment for increasing the heat radiation rate (thermal emissivity) is not provided on a partial region of the outer surface 24 of the base 21, a surface covering layer 25 obtained by the surface treatment for increasing the heat radiation rate is provided on the remaining region. Below is a detailed description of this feature with reference to FIGS. 2 to 6.

As shown in FIGS. 2 to 5, the outer surface 24 of the base 21 of the insulator 20 includes a first region 24a on which the surface covering layer is not formed and a second region 24b on which the surface covering layer 25 is formed. The second region 24b is the region of the outer surface 24 of the base 21 excluding the first region 24a.

The first region 24a corresponds to the partial region described above, and the surface treatment for increasing the heat radiation rate is not performed on the first region 24a. The outer surface 24 of the base 21 is externally exposed in the first region 24a, as shown in FIG. 4.

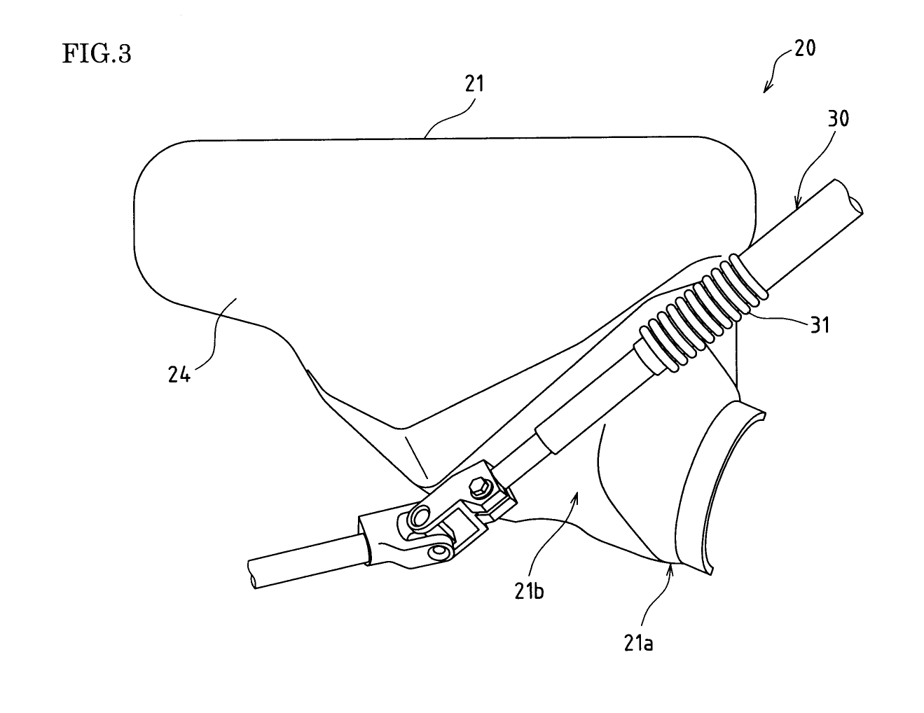

The first region 24a is a region in opposition to peripheral components disposed in the vicinity of the outer surface 24 of the base 21 (simply referred to as “peripheral components”). In the example shown in FIG. 3, peripheral components are, for instance, an intermediate shaft 30 and a bellows pipe 31 of the steering device of a vehicle. In the example shown in FIG. 3, a hollow portion 21b is formed in the base 21 of the insulator 20 such that the base 21 is opposed to the intermediate shaft 30 and the like with predetermined spacing therebetween. The hollow portion 21b is provided in the joint portion of the protruding portion 21a. In this case, the region including the outer surface of the hollow portion 21b is the above first region 24a.

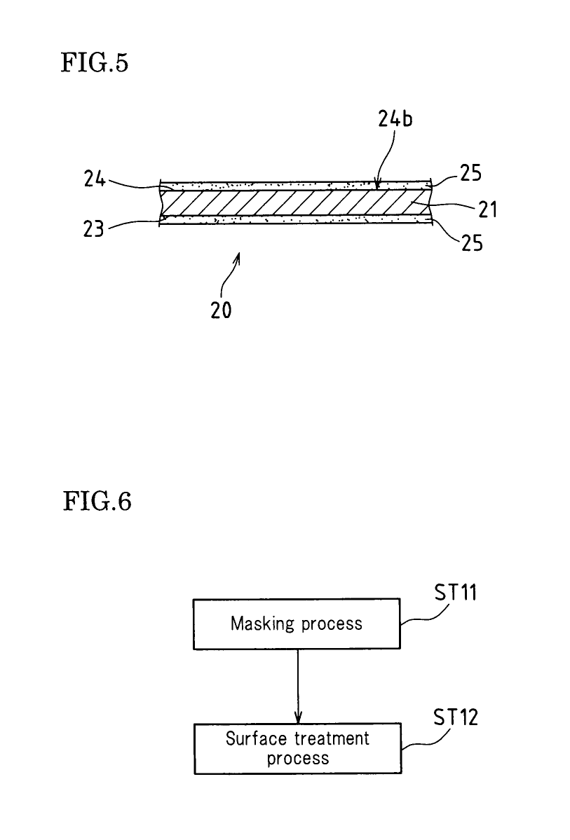

The second region 24b is a region distant from peripheral components. The second region 24b corresponds to the above remaining region, and the surface treatment for increasing the heat radiation rate is performed on the second region 24b. The surface covering layer 25 is formed on the second region 24b by this surface treatment, as shown in FIGS. 4 and 5.

Here, as shown in FIG. 6, prior to the surface treatment to be performed on the outer surface 24 of the base 21 of the insulator 20, a masking process (step ST11) is performed in order to omit the implementation of the surface treatment on the specific region of the outer surface 24 of the base 21 of the insulator 20. In the masking process, the surface of the region on which the surface treatment is not to be performed of the outer surface 24 of the base 21 is masked. Masking can be performed by, for example, attaching a masking tape or the like on the surface of the region on which the surface treatment is not to be performed.

After such a masking process, the processing proceeds to a surface treatment process (step ST12) to be performed on the outer surface 24 of the base 21 of the insulator 20. In the surface treatment process, the surface treatment is performed on the region that is not masked, and the surface treatment will not be performed on the region that is masked. Then, after performing the surface treatment, masking is removed from the outer surface 24 of the base 21 of the insulator 20. “Surface treatment” means treatment in which a certain coat, layer, or the like such as, for example, the surface covering layer 25 is formed on the base 21, and does not include a process in which such a coat, a layer, or the like is not formed (e.g., machining). Note that masking is not included in the “surface treatment” referred to here. In this embodiment, black alumite treatment is performed as the surface treatment for increasing the heat radiation rate. Black alumite treatment is treatment in which an Al₂O₃ oxide coating is formed by anodic treatment (alumite treatment), and the Al₂O₃ oxide coating is dyed black. In this case, since the Al₂O₃ oxide coating is a porous coating, it is possible to dye the Al₂O₃ oxide coating black by causing the Al₂O₃ oxide coating to adsorb black dye, for example.

Prior to performing black alumite treatment on the outer surface 24 of the base 21 of the insulator 20, the first region 24a of the outer surface 24 of the base 21 is masked. Accordingly, black alumite treatment is not performed on the masked first region 24a, whereas black alumite treatment is performed on the second region 24b that is not masked. Accordingly, as shown in FIGS. 4 and 5, the surface covering layer 25 that has been dyed black is formed on the second region 24b of the outer surface 24 of the base 21. On the other hand, as shown in FIG. 4, the surface coating layer is not formed on the first region 24a of the outer surface 24 of the base 21, and the outer surface 24 of the base 21 that has a glossy surface color (for example, silver) is externally exposed.

Consequently, the outer surface 24 of the base 21 of the insulator 20 is provided with the first region 24a having a glossy surface color and the second region 24b having a black surface color. The heat radiation rate is lower in the first region 24a having a glossy surface color than in the second region 24b having a black surface color. Note that since masking is not performed on the inner surface 23 of the base 21 of the insulator 20, the surface covering layer 25 will be formed on the entire inner surface 23.

In this embodiment, a region in opposition to peripheral components is included in the above first region 24a on which the surface treatment for increasing the heat radiation rate is not performed, and thus the following effects are obtained.

A part of heat radiated from the heat source such as the exhaust manifold 12 is absorbed by the base 21 of the insulator 20, and is radiated (emitted) from the outer surface 24 of the base 21 to the outside. The heat radiation rate is lower in the first region 24a of the outer surface 24 of the base 21 of the insulator 20 than that in the second region 24b, and thus the amount of heat dissipated from the first region 24a is smaller than the amount of heat dissipated from the second region 24b. Thus, the amount of heat dissipated from the first region 24a is reduced, compared to the case in which the surface treatment is performed on the entire outer surface 24 of the base 21. Accordingly, the amount of heat received by peripheral components from the first region 24a of the outer surface 24 of the base 21 can be reduced, and thus it is possible to suppress an excessive rise in the temperature of the peripheral components and heat damage to the peripheral components.

On the other hand, the surface covering layer 25 that has been dyed black is provided on the second region 24b of the outer surface 24 of the base 21 of the insulator 20, and thus the amount of heat dissipated from the second region 24b to the outside increases. Accordingly, heat dissipation properties of the insulator 20 can be improved as a whole.

In this embodiment, since the material of the base 21 of the insulator 20 is aluminum or an aluminum alloy, and the surface treatment performed on the outer surface 24 of the base 21 is black alumite treatment, the first region 24a having a low heat radiation rate and the second region 24b having a high heat radiation rate can be easily formed on the outer surface 24 of the base 21. Moreover, the first region 24a having a low heat radiation rate and the second region 24b having a high heat radiation rate can be easily formed on the outer surface 24 of the base 21 by simple means, namely, partially masking the outer surface 24 of the base 21 prior to performing black alumite treatment.

Although the intermediate shaft 30 and the like of the steering device were the examples of peripheral components in the above, the peripheral components are not particularly limited as long as the components are disposed in the vicinity of the outer surface 24 of the base 21 of the insulator 20. Examples of such peripheral components include various electrical devices, harnesses, hoses, and the like.

The surface treatment for increasing the heat radiation rate may be treatment other than black alumite treatment. For example, black coating treatment may be performed on the outer surface 24 of the base 21 of the insulator 20. Even in a case in which black coating treatment is performed on the outer surface 24 of the base 21 of the insulator 20, it is sufficient to mask the first region 24a of the outer surface 24 of the base 21, prior to black coating treatment.

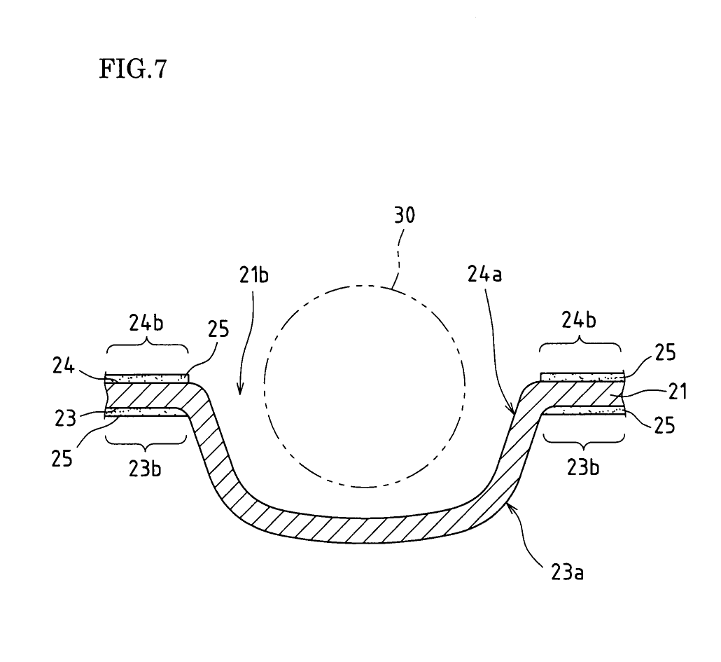

Although an example in which the surface treatment for increasing the heat radiation rate is not performed on the specific region of the outer surface 24 of the base 21 of the insulator 20 has been described in the above, it is also possible to omit the implementation of the surface treatment for increasing the heat radiation rate not only on the specific region of the outer surface 24 of the base 21, but also on a specific region of the inner surface 23 of the base 21. Specifically, as shown in FIG. 7, it is sufficient to omit the implementation of the surface covering layer obtained by black alumite treatment on a region 23a of the inner surface 23 of the base 21, the region 23a being positioned on the back side of the first region 24a of the outer surface 24. Then, it is sufficient to provide the surface covering layer 25 obtained by black alumite treatment on a region 23b of the inner surface 23 of the base 21, the region 23b being positioned on the back side of the second region 24b of the outer surface 24. In this case, it is sufficient to mask the surfaces of the specific regions 23a and 24a of the both surfaces 23 and 24 of the base 21 of the insulator 20, prior to black alumite treatment to be performed on the both surfaces 23 and 24 of the base 21.

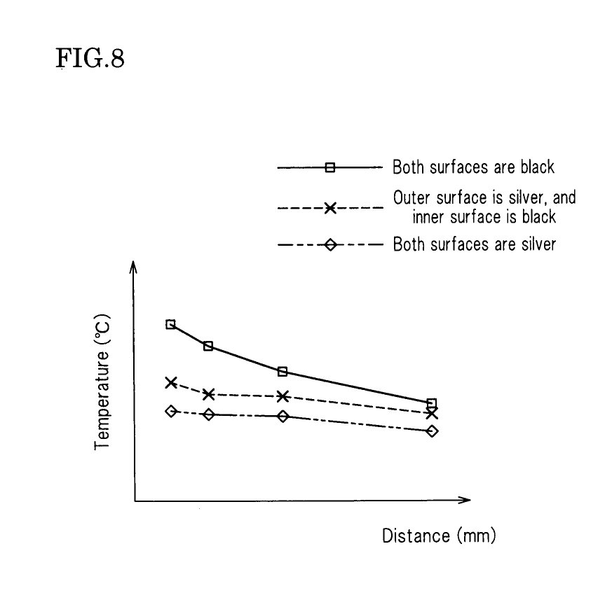

In the case of this modified example as well, an effect of enabling suppression of heat damage to peripheral components is obtained while improving the heat dissipation properties of the insulator 20 as a whole, as with the case of the embodiment described above. Here, FIG. 8 shows experimental data with regard to an effect of suppressing heat damage to a peripheral component. This experimental data shows the relationship between the distance from the outer surface 24 of the base 21 of the insulator 20 to a rubber hose and the surface temperature of the rubber hose. A rubber hose is used as a peripheral component. The two-dot chain line indicates the case of this modified example, specifically, the case in which the surface covering layer is not formed on the specific regions of the both surfaces 23 and 24 of the base 21 (the case in which the both surfaces are silver). The dashed line indicates the case of the embodiment described above, specifically, the case in which the surface covering layer is not formed on the specific region of the outer surface 24 of the base 21 (the case in which the outer surface is silver, and the inner surface is black). The solid line indicates the case of a comparative example, specifically, the case in which the surface covering layers are formed on the entirety of the both surfaces 23 and 24 of the base 21 (the case in which the both surfaces are black).

As is clear from FIG. 8, the shorter the distance from the outer surface 24 of the base 21 of the insulator 20 to the peripheral component is, the higher the surface temperature of the peripheral component is. In other words, the closer the peripheral component is disposed to the outer surface 24 of the base 21, the larger the amount of heat received by the peripheral component is. However, in the case of the embodiment described above and in the case of this modified example, the surface temperature of the peripheral component is lower than that in the case of the comparative example, and the closer the peripheral component is disposed to the outer surface 24 of the base 21, the greater a fall in the surface temperature of the peripheral component is, compared to the case of the comparative example. This shows that as a countermeasure to heat damage to peripheral components, an effective means is to omit the implementation of the surface treatment for increasing the heat radiation rate on the specific region of the outer surface 23 of the base 21 of the insulator 20 or the specific regions of the both surfaces 23 and 24.

### Second Embodiment

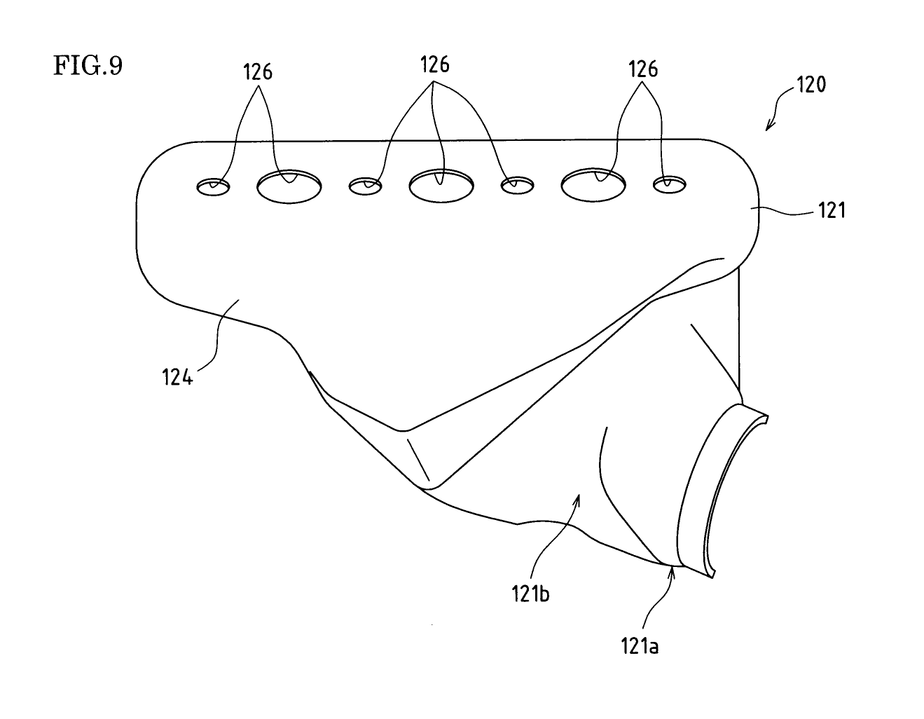

An insulator 120 according to a second embodiment will be described below with reference to FIGS. 9 to 11.

A schematic configuration of the insulator 120 according to this embodiment is substantially the same as that of the insulator 20 according to the above first embodiment (see FIG. 1). A difference in the schematic configuration between the insulator 120 and the insulator 20 according to the above first embodiment is that a plurality of openings 126 are formed in a base 121 of the insulator 120. The openings 126 serve as, for instance, an inlet and an outlet for ventilation wind (e.g., traveling wind) that flows into the engine room of the vehicle in which the internal combustion engine 10 is installed. In this embodiment, the openings 126 are each formed in a substantially round shape.

A feature of this embodiment is that surface treatment is not performed on a specific region, rather than performing the surface treatment on an entire outer surface 124 of the base 121 of the insulator 120. Specifically, a feature is that although a surface covering layer obtained by surface treatment for increasing strength (hardness) is not provided on a partial region of the outer surface 124 of the base 121, a surface covering layer (surface hardened layer) 125 obtained by the surface treatment for increasing strength is provided on the remaining region. Below is a detailed description of this feature with reference to FIGS. 9 to 11.

As shown in FIGS. 9 to 11, the outer surface 124 of the base 121 of the insulator 120 includes first regions 124a on which a surface hardened layer is not formed and a second region 124b on which the surface hardened layer 125 is formed. The second region 124b is the region of the outer surface 124 of the base 121 excluding the first regions 124a.

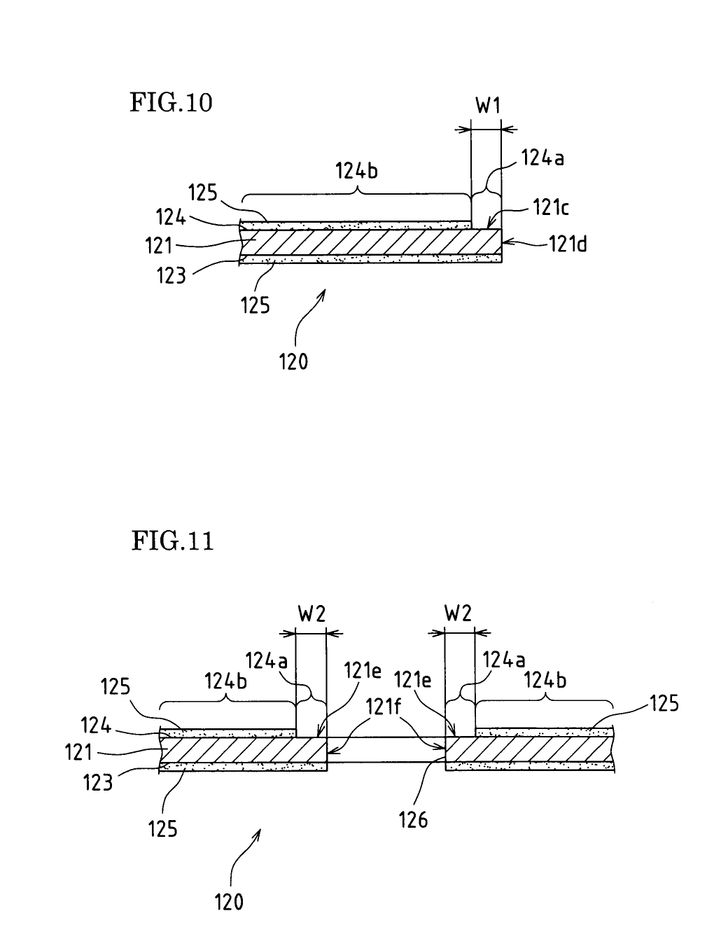

The first regions 124a correspond to the partial region described above, and the surface treatment for increasing strength is not performed on the first regions 124a. In the first regions 124a, the outer surface 124 of the base 121 is externally exposed, as shown in FIGS. 10 and 11.

The first regions 124a are regions that are likely to be subjected to stress due to vibration of the base 121. Examples of such regions that are likely to be subjected to the stress due to vibration include an outer edge portion 121c of the base 121 of the insulator 120 as shown in FIG. 10 and a circumference portion 121e of each of the openings 126 provided in the base 121 as shown in FIG. 11. More specifically, the outer edge portion 121c of the base 121 is a region having a predetermined width W1 from an outer edge 121d of the base 121 as shown in FIG. 10. The width W1 of the outer edge portion 121c of the base 121 is set to 1 to 50 mm, for example. Further, the circumference portion 121e of each of the openings 126 of the base 121 is a region having a predetermined width W2 from a circumference 121f of each of the openings 126, as shown in FIG. 11. The width W2 of the circumference portions 121e of the base 121 is set to 1 to 50 mm, for example.

The second region 124b is a region distant from the outer edge portion 121c of the base 121 and the circumference portions 121e of the openings 126. The second region 124b corresponds to the remaining region described above, and the surface treatment for increasing strength is performed on the second region 124b. The surface hardened layer 125 is formed on the second region 124b by this surface treatment, as shown in FIGS. 10 and 11.

In this embodiment as well, a masking process is performed prior to the surface treatment to be performed on the outer surface 124 of the base 121 of the insulator 120 (see FIG. 6) in order to omit the implementation of the surface treatment on the specific regions of the outer surface 124 of the base 121 of the insulator 120, as with the case of the above first embodiment.

In this embodiment, hardening treatment such as, for example, alumite treatment is performed as the surface treatment for increasing strength. If alumite treatment is performed on the outer surface 124 of the base 121 of the insulator 120, the surface hardened layer 125 made of Al₂O₃ is formed on the outer surface 124 of the base 121. Then, prior to performing alumite treatment on the outer surface 124 of the base 121 of the insulator 120, the first regions 124a of the outer surface 124 of the base 121 are masked. Thus, alumite treatment is not performed on the masked first regions 124a, whereas alumite treatment is performed on the second region 124b that is not masked. Accordingly, the surface hardened layer 125 is formed on the second region 124b of the outer surface 124 of the base 121, as shown in FIGS. 10 and 11. On the other hand, the surface hardened layer is not formed on the first regions 124a of the outer surface 124 of the base 121, and the outer surface 124 of the base 121 is externally exposed.

Consequently, the outer surface 124 of the base 121 of the insulator 120 is provided with the first regions 124a on which the surface hardened layer is not formed, and the second region 124b on which the surface hardened layer 125 has been formed. Although the strength (hardness) of the first regions 124a on which the surface hardened layer is not formed is lower than that of the second region 124b on which the surface hardened layer 125 has been formed, the flexibility of the first regions 124a is higher, which increases the deformation resistance thereof.

In this embodiment, the above first regions 124a on which the surface treatment for increasing strength (hardness) is not performed include the outer edge portion 121c of the base 121 and the circumference portions 121e of the openings 126 that are likely to be subjected to stress due to vibration, and thus the following effects will be obtained.

Deformation resistance of the outer edge portion 121c of the base 121 of the insulator 120 and the circumference portions 121e of the openings 126 is increased, compared to a case in which the surface treatment is performed on the entire outer surface 124 of the base 121. Accordingly, even if vibration from the vibration source such as the exhaust manifold 12 is transmitted to the base 121 of the insulator 120, cracks and the like will not be easily formed in the outer edge portion 121c of the base 121 and the circumference portions 121e of the openings 126. In this way, the durability of the base 121 of the insulator 120 can be secured.

In this embodiment, the material of the base 121 of the insulator 120 is aluminum or an aluminum alloy, and the surface treatment performed on the outer surface 124 of the base 121 is alumite treatment, and thus the first regions 124a having high deformation resistance and the second region 124b having high strength can be easily formed on the outer surface 124 of the base 121. Moreover, the first regions 124a having high deformation resistance and the second region 124b having high strength can be easily formed on the outer surface 124 of the base 121 by simple means such as partially masking the outer surface 124 of the base 121 prior to performing alumite treatment.

Although the above is a description of a case in which the openings 126 are provided in the base 121 of the insulator 120, it is sufficient to omit the implementation of the surface treatment for increasing strength only on the outer edge portion of the base in a case in which an opening is not provided in the base. Specifically, only the outer edge portion of the base will serve as the first region described above. In this case, it is sufficient to mask only the outer edge portion of the base prior to the surface treatment.

Further, the surface treatment for increasing strength may be hardening treatment other than alumite treatment. In this case as well, it is sufficient to mask the first regions 124a of the outer surface 124 of the base 121 prior to hardening treatment.

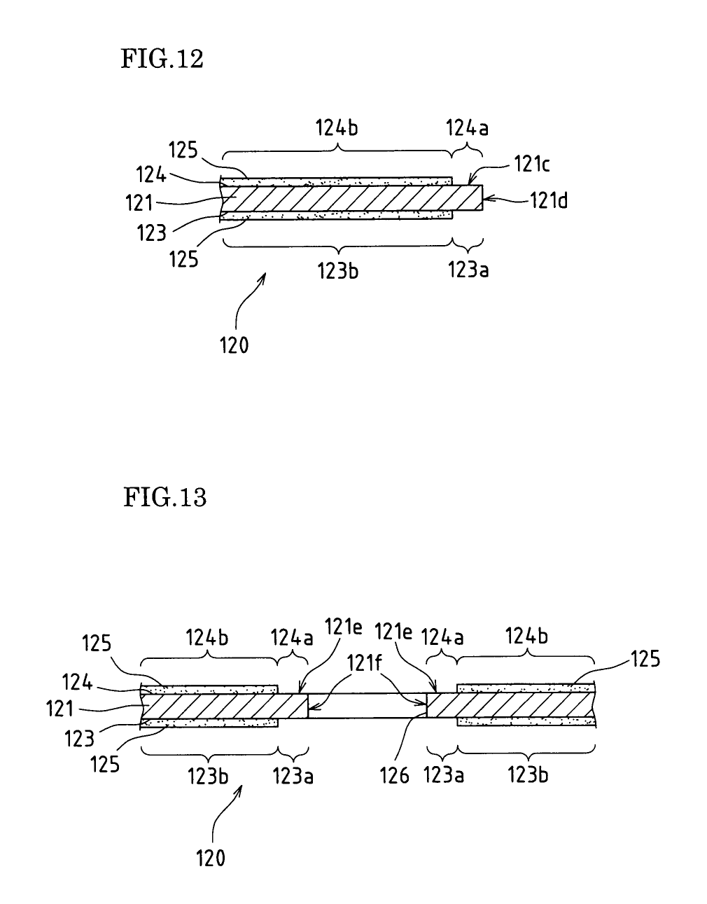

Although the above is an example in which the surface treatment for increasing strength is not performed on the specific regions of the outer surface 124 of the base 121 of the insulator 120, it is also possible to omit the implementation of the surface treatment for increasing strength not only on the specific regions of the outer surface 124 of the base 121, but also on specific regions of an inner surface 123 of the base 121. Specifically, it is sufficient to omit the provision of the surface covering layer obtained by alumite treatment on regions 123a of the inner surface 123 of the base 121, the regions 123a being positioned on the back side of the first regions 124a of the outer surface 124, as shown in FIGS. 12 and 13. Then, it is sufficient to provide the surface hardened layer 125 obtained by alumite treatment on a region 123b of the inner surface 123 of the base 121, the region 123b being positioned on the back side of the second region 124b of the outer surface 124. In this case, it is sufficient to mask the surfaces of the specific regions 123a and 124a of the both surfaces 123 and 124 of the base 121 of the insulator 120, prior to alumite treatment to be performed on the both surfaces 123 and 124 of the base 121.

In the case of this modified example as well, an effect of enabling securing the durability of the base 121 of the insulator 120 is obtained as with the case of the embodiment described above. In this case, since flexibility of the outer edge portion 121c of the base 121 and the circumference portions 121e of the openings 126 is higher than that in the case of the embodiment described above, it is possible to further increase the durability of the base 121 of the insulator 120.

### Other Embodiments

The present invention is not limited to only the above first and second embodiments, and all modifications and applications encompassed within the scope of the claims and a range of equivalency therewith are possible.

(1) The present invention is also applicable to a configuration in which the above first and second embodiments are combined. In this configuration, the surface treatment for increasing the heat radiation rate and strength is not performed on partial regions of the outer surface of the base of the insulator, and the surface treatment for increasing the heat radiation rate and strength is performed on the remaining region. The partial regions of the outer surface of the base include a region in opposition to peripheral components, the outer edge portion of the base, and the circumference portions of the openings of the base. In this case, it is preferable that the material of the base of the insulator is aluminum or an aluminum alloy, and the surface treatment performed on the outer surface of the base is black alumite treatment.

(2) Although the above is a description of a case in which the insulator is constituted by only one base, the present invention is also applicable to an insulator having a plurality of bases. For example, an insulator may be constituted by two laminated bases. In this case, a configuration may be adopted in which a member for sound absorption, a member for vibration absorption, or the like is sandwiched in the gap between the two laminated bases. Note that in the case of an insulator having a plurality of bases, the outer surface of a base means a surface on the side that is not in opposition to an exhaust manifold, in other words, a surface on the outer side of the base disposed most outward. Further, the inner surface of a base means a surface on the side in opposition to an exhaust manifold, in other words, the surface on the inner side of the base disposed most inward.

Further, the present invention is also applicable to an insulator in which a process such as corrugation processing has been performed on a base.

(3) Although the above is an example in which the present invention is applied to an insulator that covers the upper side the exhaust manifold, the present invention is also applicable to an insulator that covers other portions of the exhaust manifold. Further, the present invention is also applicable to an insulator that covers substantially the entirety of the exhaust manifold.

Further, the present invention is also applicable to an insulator constituted so as to be divided into a plurality of portions. For example, an insulator can be constituted so as to be divided into a portion that covers the upper side of the exhaust manifold and a portion that covers the lower side of the exhaust manifold. In this case, the present invention is applicable to each portion into which the insulator has been divided.

(4) Although the above is an example in which the present invention is applied to an insulator that covers the exhaust manifold, the present invention is also applicable to an insulator that covers an exhaust system component of the internal combustion engine other than the exhaust manifold. Examples of such an exhaust system component of the internal combustion engine include an exhaust pipe, a catalytic converter, a muffler, and the like.

### INDUSTRIAL APPLICABILITY

The present invention can be utilized for an insulator that is disposed in opposition to exhaust system components of an internal combustion engine with spacing therebetween.

1. An insulator disposed in opposition to an exhaust system component of an internal combustion engine with spacing therebetween, the insulator comprising:
a metal base having heat resistance,
wherein a surface covering layer obtained by surface treatment is not provided on a partial region of an outer surface of the base, the outer surface being on a side that is not in opposition to the exhaust system component, and the surface covering layer obtained by the surface treatment is provided on a remaining region.

2. The insulator according to claim 1,
wherein the partial region is masked, prior to the surface treatment.

3. The insulator according to claim 1,
wherein the surface treatment is surface treatment for increasing a heat radiation rate, and
the partial region includes a region in opposition to a peripheral component disposed in the vicinity of the outer surface of the base.

4. The insulator according to claim 3,
wherein the base is made of aluminum or an aluminum alloy, and
the surface treatment is black alumite treatment.

5. The insulator according to claim 3,
wherein the surface covering layer obtained by the surface treatment is not provided on a region of an inner surface of the base, the inner surface being on a side in opposition to the exhaust system component, and the region being positioned on a back side of the partial region of the outer surface, and
the surface covering layer obtained by the surface treatment is provided on a region of the inner surface, the region being positioned on a back side of the remaining region of the outer surface.

6. The insulator according to claim 1,
wherein the surface treatment is hardening treatment for increasing strength, and
the partial region includes an outer edge portion of the base.

7. The insulator according to claim 6,
wherein if an opening is formed in the base, the partial region further includes a circumference portion of the opening.

8. The insulator according to claim 6,
wherein the base is made of aluminum or an aluminum alloy, and the hardening treatment is alumite treatment.

9. The insulator according to claim 6,
wherein the surface covering layer obtained by the surface treatment is not provided on a region of an inner surface of the base, the inner surface being on a side in opposition to the exhaust system component, and the region being positioned on a back side of the partial region of the outer surface, and
the surface covering layer obtained by the surface treatment is provided on a region of the inner surface, the region being positioned on a back side of the remaining region of the outer surface.

10. The insulator according to claim 1,
wherein the surface treatment is surface treatment for increasing a heat radiation rate and strength, and
the partial region includes a region in opposition to a peripheral component disposed in the vicinity of the outer surface of the base, an outer edge portion of the base, and a circumference portion of an opening provided in the base.

11. The insulator according to claim 10,
wherein the base is made of aluminum or an aluminum alloy, and
the surface treatment is black alumite treatment.

12. The insulator according to claim 2,
wherein the surface treatment is surface treatment for increasing a heat radiation rate, and
the partial region includes a region in opposition to a peripheral component disposed in the vicinity of the outer surface of the base.

13. The insulator according to claim 4,
wherein the surface covering layer obtained by the surface treatment is not provided on a region of an inner surface of the base, the inner surface being on a side in opposition to the exhaust system component, and the region being positioned on a back side of the partial region of the outer surface, and
the surface covering layer obtained by the surface treatment is provided on a region of the inner surface, the region being positioned on a back side of the remaining region of the outer surface.

14. The insulator according to claim 2,
wherein the surface treatment is hardening treatment for increasing strength, and
the partial region includes an outer edge portion of the base.

15. The insulator according to claim 7,
wherein the base is made of aluminum or an aluminum alloy, and
the hardening treatment is alumite treatment.

16. The insulator according to claim 7,
wherein the surface covering layer obtained by the surface treatment is not provided on a region of an inner surface of the base, the inner surface being on a side in opposition to the exhaust system component, and the region being positioned on a back side of the partial region of the outer surface, and
the surface covering layer obtained by the surface treatment is provided on a region of the inner surface, the region being positioned on a back side of the remaining region of the outer surface.

17. The insulator according to claim 8,
wherein the surface covering layer obtained by the surface treatment is not provided on a region of an inner surface of the base, the inner surface being on a side in opposition to the exhaust system component, and the region being positioned on a back side of the partial region of the outer surface, and
the surface covering layer obtained by the surface treatment is provided on a region of the inner surface, the region being positioned on a back side of the remaining region of the outer surface.

18. The insulator according to claim 2,
wherein the surface treatment is surface treatment for increasing a heat radiation rate and strength, and
the partial region includes a region in opposition to a peripheral component disposed in the vicinity of the outer surface of the base, an outer edge portion of the base, and a circumference portion of an opening provided in the base.
